(19) United States
(12) Patent Application Publication
(10) Pub. No.: US 2008/0220147 A1
(43) Pub. Date: Sep. 11, 2008

(54) Liquid Mixture Comprising Coffee and Vegetables Extracts

(76) Inventors: Carlos Alberto Barrera Rivera, Bogota (CO); Hugo Poveda Castaneda, Bogota (CO)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 11/568,201

(22) PCT Filed: Apr. 21, 2005
(86) PCT No.: PCT/IB05/01164

§ 371 Date: Feb. 5, 2008

(30) Foreign Application Priority Data
Apr. 23, 2004 (CO) 04-37577

(51) Int. Cl. A23L 1/221; A23F 5/24

(52) U.S. Cl. 426/650; 426/655

(57) ABSTRACT

The invention relates to a composition comprising a liquid mixture containing a liquid coffee extract and a liquid extract selected from laurel, thyme, clove, celery oregano, pepper, cayenne pepper, garlic, onion and tomato, individually or as part of a mixture.

### REFERENCE TO RELATED APPLICATIONS

This application claims the benefit of priority of Columbian Application No. 04-37577 filed Apr. 23, 2004, and International Application No. PCT/IB2005/001164 filed Apr. 21, 2005, which are relied on and incorporated herein by reference.

The liquid mixture of plant liquid extracts from laurel, thyme, clove, celery oregano, pepper, cayenne pepper, garlic, onion and tomato along with thickener, preserving and texturizing additives provide a liquid mixture having flavors, acid, sweet and salty, which when combined with the bitter flavor raised by the mixture of a liquid coffee extract, provides a global flavor of the final liquid mixture that is pleasant and significantly different with respect to the liquid mixtures commonly used in traditional sauces potentializing the original flavor of the cooked food to which it is added in spray or bath.

### BACKGROUND OF THE INVENTION

It is usual to prepare the food for consumption along with the aspersion or bathed in a liquid extract mixture comprising plant compounds commonly known as sauce, which is a liquid mixture made of compound that give acid, sweet and salty flavors providing a reinforcement to the global flavor of this type of foods. Such reinforcement given to the gustative properties usually lacks of the bitter flavor of the coffee which in equilibrium with the other basic flavors strengthen and provides a greater and complete satisfaction when tasted and increases the own desire for consuming the prepared and ready to consume food.

### DETAILED DESCRIPTION OF THE INVENTION

The present invention refers to a composition of a liquid mixture of plant extracts containing a liquid coffee extract, which in appropriate amounts will provide a bitter flavor to the final liquid mixture a complete gustative and palatability satisfaction to the cooked food to which it is incorporated.

The process for obtaining the coffee-based liquid mixture for cooked food is described below.

The liquid coffee extract is obtained from an infusion made of water and roasted coffee in order to obtain a measured color in brightness degrees of around 17 and 22, and then pulverized to a particle size between 100 and 900 μm, preferably between 200 and 600 μm, after which it is subjected to an extraction through continuous filtration, until a liquid coffee extract having a concentration around 0.5 to 5 parts of soluble coffee solids to 100 parts of liquid coffee extract is obtained.

The mixture of liquid coffee extract and the remaining components of the whole liquid mixture have a proportion between 5 and 25 parts of liquid coffee extract to 100 parts of the whole liquid mixture.

An direct infusion with water and dehydrated extracts of laurel, thyme, clove, celery oregano, pepper, cayenne pepper, garlic, and onion was independently prepare at a temperature between 80 and 100° C. and pulverized to a particle size between 100 and 900 μm, in order to obtain a liquid extract having a concentration between 10 and 30 parts of total soluble solids to 100 parts of total infusion.

In order to stabilize, preserve and texturize the liquid mixture of plant extracts, a water-based mixture of additives in appropriate proportions was diluted.

The additive mixture is made of sucrose, acetic acid food grade, mustard flour, sodium chloride, soybean protein, starch, sodium benzoate, carboxymethylcellulose food grade and citric acid also food grade.

The plant extracts and the additives were mixed under slow and continuous stirring at a temperature between 60 and 100° C. When the final mixture had a gel appearance, the liquid coffee extract was added and the final mixture was mixed and homogenized. To the final mixture thus obtained, artificial chicken, cow, pork or fish flavoring and/or perfuming may be added in meat sauces.

The above sauce or liquid mixture was poured in a bathing way into chicken, cow, pork and fish cooked meat, cold (between 4° C. and 10° C.) and warm (between 50° C. and 70° C.). The concept of trained tasters determined that the liquid mixture enhanced in a significant and pleasant manner the global flavor of the meats to which it was added cold or warm. Furthermore, the aspect of a dark brown color and global flavor of the sauce or liquid mixture was interpreted as correct and desirable from the part of the attending panelists.

### DETAILED DESCRIPTION OF THE DRAWINGS

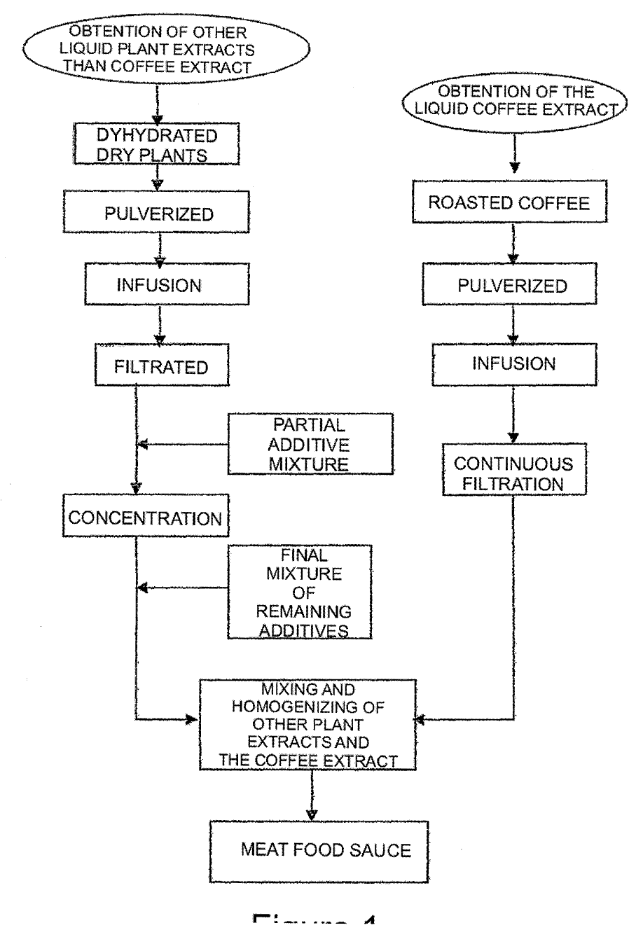

The operations for obtaining the present invention are shown in the annexed FIG. 1. In FIG. 1, the different plant extracts are referred as the laurel, thyme, clove, celery oregano, pepper, cayenne pepper, garlic, onion and tomato extracts.

1. A composition of a liquid mixture comprising a liquid coffee extract and a liquid extract selected from laurel, thyme, clove, celery oregano, pepper, cayenne pepper, garlic, onion and tomato, independent or mixed.

2. The composition of the liquid mixture according to claim 1 characterized in that it further comprises a compound selected from sucrose, mustard flour, sodium chloride, solid soybean protein, starch, sodium benzoate, acetic acid, carboxymethylcellulose and citric acid, all food grade, alone or mixed.

3. The composition of the liquid mixture according to claim 1 characterized in that the liquid coffee extract has a concentration of 0.5 and 5 parts of soluble coffee solids.

4. The composition of the liquid mixture according to claim 1 characterized in that the liquid coffee extract is present in the range of 5 and 25 parts of liquid coffee extract to 100 parts of the whole liquid mixture.

5. The composition of the liquid mixture according to claim 1 characterized in that with the exception of the liquid coffee extract, the liquid mixture of the other compounds has a concentration of 0.5 to 30 parts of soluble solids to each 100 parts of the total liquid mixture.

6. The composition of the liquid mixture according to claim 1 characterized in that besides the liquid extracts, it comprises one or more artificial chicken, cow, pork or fish flavoring, each alone or in mixture.

7. The composition of the liquid mixture according to claim 1 characterized in that besides the liquid extracts, it comprises one or more artificial chicken, cow, pork or fish perfuming, each alone or in mixture.
